(19) United States
(12) Patent Application Publication
(10) Pub. No.: US 2007/0268511 A1
(43) Pub. Date: Nov. 22, 2007

(54) Secure document printing

(75) Inventors: John F. Crichton, Honeoye Falls, NY (US); Jason Morgan, Fairport, NY (US); Raymond Rossborough, Geneseo, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/437,981

(22) Filed: May 19, 2006

(51) Int. Cl. G06K 15/00

(52) U.S. Cl. 358/1.14

(57) ABSTRACT

A method and system for printing documents with one or more embedded security features is provided. Security features are embedded in the document by co-printing first and second toner on a receiver before fixation by a fixing station. The combination of first and second toners in the image results in image elements that easily show alteration or are undetectable by visual means.

### FIELD OF THE INVENTION

The present invention relates generally to printing documents with secure image elements and, more particularly, to a method and apparatus for aligning and printing secure image elements within a document to create a secure document and method.

### BACKGROUND OF THE INVENTION

Billions of personal checks, business checks, tickets, pay stubs, vouchers, and other commercial documents are processed each year. The volume of documents being processed continues to increase despite the availability of paperless methods of making payments and/or transferring money.

The susceptibility of printed documents to fraudulent alteration costs the industry billions of dollars each year. Alteration takes the form of printing non-standard documents (forgery) and/or removal, addition or alteration of image elements on original documents. The industry is in need of methods to quickly and accurately assess the authenticity of a document and make document alteration more difficult.

Many schemes exist for printing secure documents. These generally fall into two categories, those that involve substrate manipulation and those that involve addition of image content. Examples of substrate manipulation include US20030211299 A1 which describes a coating for a retroreflective document which renders the surface of the document receptive to toners and inks printed thereon while not substantially interfering with the retroreflective properties of the underlying substrate. Methods for fabricating the document are also provided.

U.S. Pat. No. 5,888,622A provides a coated cellulosic web product and coating composition which provides enhanced toner adhesion for documents printed using noncontact printing devices such as ion deposition printers. The toner adhesion enhanced coating cellulosic product and composition comprises a cellulosic web having first and second major surfaces with at least one of the major surfaces having coated thereon a layer of a polymeric toner receptor.

U.S. Pat. No. 6,086,708A details a method of making a document, such as a check or stock certificate, having enhanced security against counterfeiting. The document includes a strip of foil having a three dimensional light diffracting image thereon affixed to the document. The strip of foil may be affixed to the document before or after the background printing or face printing of the document is completed. In this manner, the light-diffracting strip may be printing on by the background and face printing of the document as desired.

Examples of methods that involve manipulation of image content or imaging materials include US20050282077A1, which describes a toner for printing documents that are difficult to chemically, or physically forge and that are readily easy to visually verify and methods of using and forming the toner are disclosed. The toner includes a colorant for printing an image on a surface of a document and a dye for forming a latent version of the image underneath a surface of a substrate. An image formed using the toner of the invention is readily verified by comparing the colorant-formed image and the dye-formed image. In addition, if a solvent is used in an attempt to alter the printed image on the substrate, the dye migrates or diffuses to indicate tampering with the document.

US20050142468A1 describes a method of printing documents, for example bank checks, with a pantograph. Documents printed as described may include a digitally variable pantograph and other enhancements. The invention is particularly useful for enhanced security documents and the production thereof. US20050142469A1 describes a printing system, process and product with microprinting. Documents printed as described may include digitally variable microprint and other enhancements. The invention is particularly useful for enhanced security documents and the production thereof.

Despite these methods of security enhancement, document forgery and manipulation is still a problem.

### SUMMARY OF THE INVENTION

The present invention provides an electrophotographic printing method, which generates secure documents with toner image elements with greatly improved resistance to tampering or fraudulent alteration. Document security features are realized by printing one or more toners on a receiver where the combination of the toners is co-printed on the receiver before fixation. Using this method a variety of security features can be realized.

### BRIEF DESCRIPTION OF THE DRAWINGS

The file of this patent contains at least one drawing executed in color. Copies of this patent with color drawing(s) will be provided by the Patent and Trademark Office upon request and payment of the necessary fee.

FIG. 1 presents a flow chart of the inventive printing process and system.

FIG. 2 presents a schematic diagram of an electrographic marking or reproduction system in accordance with the present invention.

FIG. 3 presents a schematic diagram of an imaging unit in an electrographic marking or reproduction system in accordance with the present invention.

FIG. 4 presents a diagram of a printed character composed of toner image elements in accordance with the present invention

FIG. 5 presents a diagram of a printed character composed of toner image elements in accordance with the present invention.

FIG. 6 presents a diagram of a printed character composed of toner image elements in accordance with the present invention.

FIG. 7 presents a secure document in accordance with the present invention.

FIG. 8 presents a diagram of a printed character composed of toner image elements in accordance with the present invention.

FIG. 9 presents a diagram of a printed character composed of toner image elements in accordance with the present invention.

FIG. 10 presents a diagram of a printed character composed of toner image elements in accordance with the present invention.

FIG. 11 presents a diagram of a printed character composed of toner image elements in accordance with the present invention.

### DETAILED DESCRIPTION OF THE INVENTION

The preferred embodiment of this invention will be described in connection with an electrographic printer, by way of example, because this invention is contemplated to be particularly beneficial in such an application. It will be appreciated by those skilled in the art having reference to this specification that this invention can also be used in any type of electrographic system, of any size or capacity or other printer or image processor that has good registration between colors and some software, but it could be used on any multi-color printer with good registration. As such, this description is provided by way of example only, and is not intended or contemplated to limit the true scope of the invention as claimed. Most checks are printed on preprinted stock and in-filled by either hand infilling with an ink pen or digital printing using black toner. If, for some reason, the toner is not solidly adhered to the paper, then it is susceptible to removal and alteration can be achieved by simply reprinting the area removed with the fraudster's own information using a black toner. One way of making it more difficult to reprint a check is to add a different color to the original print as a slightly wider image under the high contrast imaging toner.

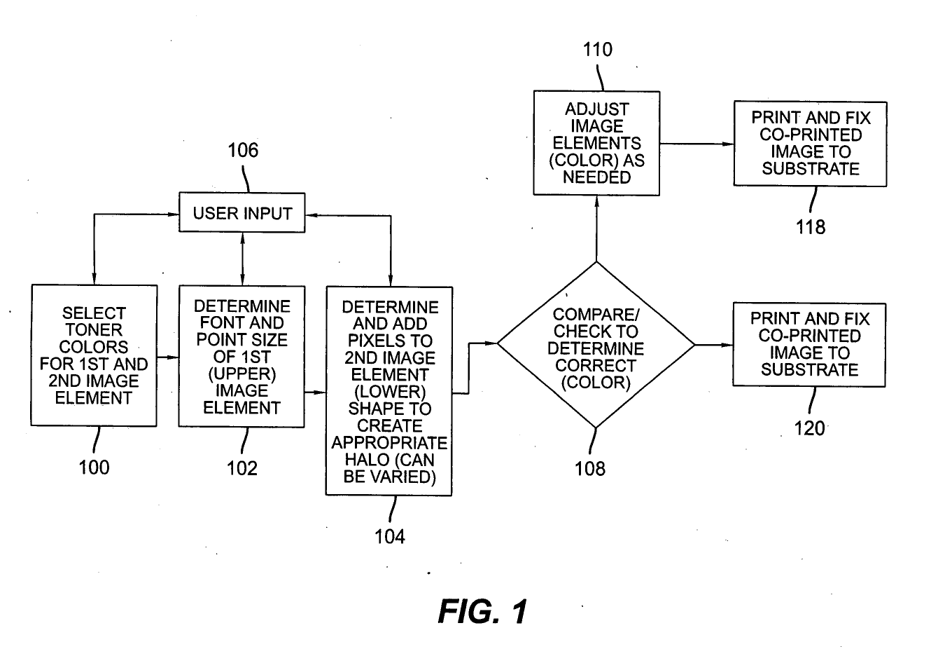

Referring now to FIG. 1, a flow chart of one exemplary method and related system for printing secure documents is illustrated in a general schematic sense, to provide a general context for the preferred embodiments of the invention; it is contemplated that this invention will be applicable to a wide range of printing machines. The method according to a preferred embodiment of the invention starts with selecting a toner characteristic such as color, for the first and second image element, as shown in step 100, before printing the image elements on a receiver. The receiver could be a non-printed or a preprinted receiver of any composition that would receive the toner including paper, metal, cloth, wax, etc as well as material combinations. In a preferred embodiment the image element of interest, the first image element, that will be incorporated into the secure document has at least the font and point size analyzed and stored in a controller, as shown in step 102, so that pixels can be added to the respective second, or companion, image element shape to create an appropriate halo as represented by step 104. This halo essentially expands the image element on at least one side, or all-around, forming a halo as will be discussed in greater detail later. User input can alter any of these steps as shown by step 106.

The two image elements are then compared in step 108 to identify and, if necessary, correct any boundary effects or other problems as shown in step 110 so that the one image elements are printed onto or next to the other image element and then optionally fixing the image with heat and pressure, UV, IR, solvent, or any other fixing method known in the art, represented by step 118, 120 to produce a final secure document. This is sometimes referred to as fusing and can include fixing by heat and/or pressure as well as UV radiation, IR radiation, solvent or any other fixing method. The controller required for this technique would be required to select the toner colors, determine the font and point size of the upper character, and add pixels to the bottom character shape to create the appropriate halo. The halo size relative to the character's font and point size may be a variable subject to customer wishes or a default size. Side by side or top and bottom combinations would require the appropriate software to parse the characters for their color treatment either at the bit map level or before.

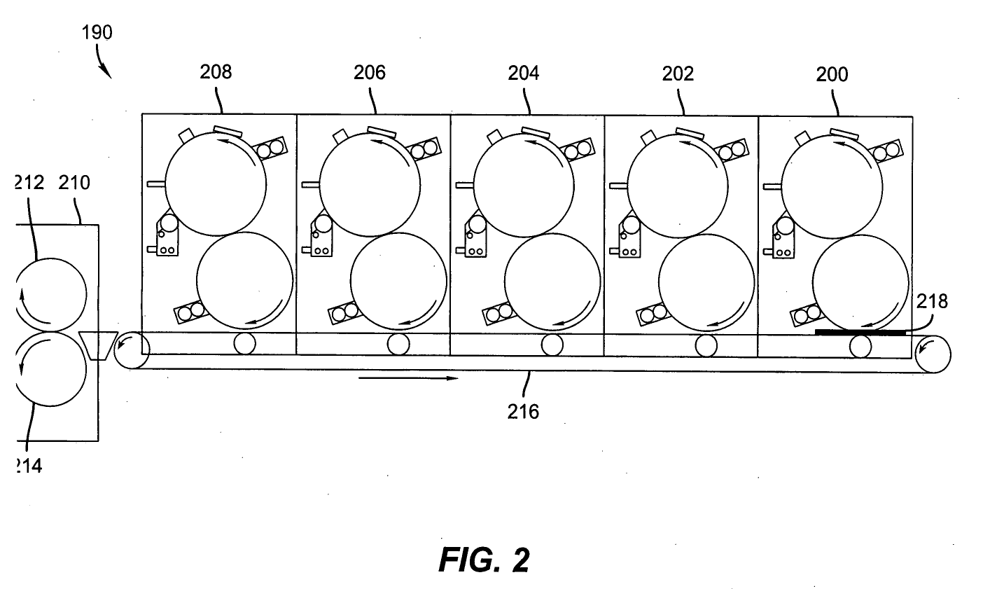

FIG. 2 shows a schematic of a device 190, also referred to as a printing device, used for printing image elements. The device 190 includes a plurality of development stations 200, 202, 204, 206, and 208. Each of these development stations may apply toner image elements on the receiver 218. An example of the device 190 shown in FIG. 2 would be the NexPress 2100 digital printer sold by NexPress Solutions, Inc. In a preferred embodiment, non-magnetic toner image elements are first applied to the receiver by development stations 200, 202, 204, and 206. Also shown in FIG. 2 are fixing members 212 and 214 and belt 216, that carries receiver 218, that will be discussed in more detail below.

In a preferred implementation, the non-magnetic toner will have a viscosity of between 1 and 40,000 cpoise (40 kcP) and an elasticity (tan delta) of between 1 and 20 where elasticity is defined as the ratio of the elastic modulus to the storage modulus of the toner as measured at 120 C on a parallel plate rheometer. In a preferred embodiment, the non-magnetic toner will have a viscosity between 10,000 and 15,000 cpoise(cp) and a tan delta between 2 and 4.5. In a more preferred embodiment, the non-magnetic toner will have a viscosity between 10,000 cp and 12,000 cp and a tan delta between 2 and 2.5. The non-magnetic toner may contain optical, UV, or IR sensitive pigments. The non-magnetic toner image elements will preferably be applied to the receiver at an optical transmission density of 0.01 to 5.00. One preferred non-magnetic toner is a NexPress DryInk sold by NexPress Solutions, Inc.

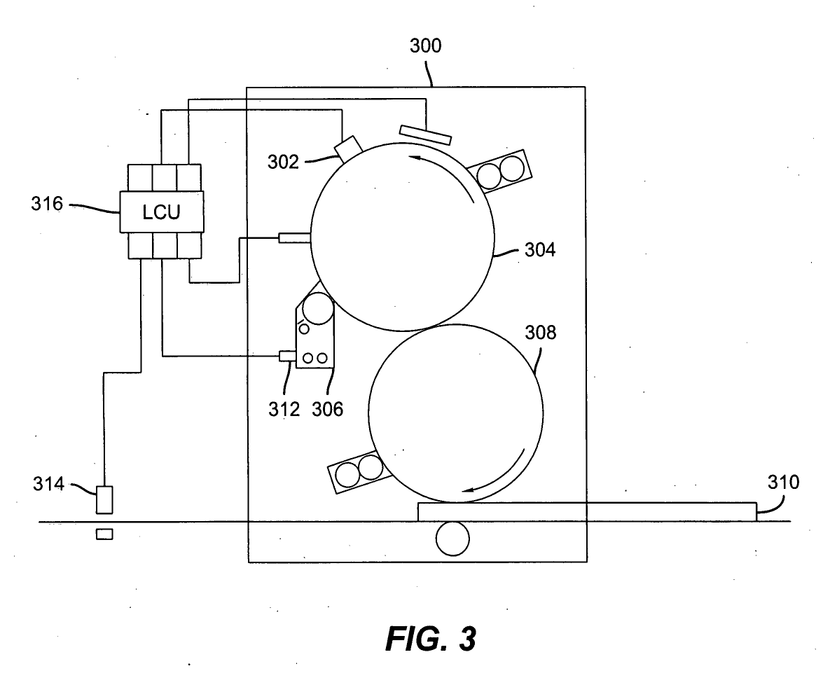

A detailed schematic of one exemplary imaging unit, such as imaging unit 200 shown in FIG. 2 is shown in FIG. 3. The imaging unit 300 is used to print magnetic and non-magnetic toners on receiver 218 and includes an optical writer 302, a charging element 310, an image forming member 304, a development station 306, a transfer member 308, a toner concentration sensor 312, an image density sensor 314, and a logic control unit 316. A uniform charge is applied to the imaging forming member 304 by the charging element 310. The image elements are written in the charge layer by discharging the charged layer with focused light from the optical writer 302. Examples of this image forming process are discussed in U.S. Pat. No. 6,909,856.

The image elements written by the writer form the latent image, which is then toned by the development station 306. The development station 306 contains magnetic or non-magnetic toner for example NexPress DryInk or similar and a magnetic carrier such as that detailed in U.S. Pat. No. 4,546,060 A. Magnetic toner will have a viscosity between 1 and 200,000 cp and an elasticity of between 0.1 and 20. The magnetic toner may contain between 10 and 30 parts per hundred (pph) magnetic iron oxide such as that sold by Magnox-Pulaski Inc. The magnetic or non-magnetic toner may optionally contain optical, UV, or IR pigments and optional abrasion aids. Magnetic toner such as that detailed in U.S. Pat. No. 6,766,136 B2 is preferred. The toner image element is then transferred to the transfer member 308 and then to the receiver 318. Subsequent imaging units, such as 202, 204, 206, and 208 from FIG. 2, apply additional image elements to receiver 318 in a similar manner.

Referring now to FIG. 2, the image on receiver 218 with the accumulated toner image elements is fixed by heat, pressure, UV or IR radiation, solvent, or other means well known in the art. In a preferred embodiment, the image is fixed via heat and pressure by fixing members 212 and 214. The preferred temperature of image fixation is between 150 and 200 C and pressures from 40 pounds/in² to 400 pounds/in². A most preferred embodiment uses fixing temperatures between 160 C and 185 C and pressures between 40 pounds/in² to 400 pounds/in²

Fixing of the combined toner image elements results in an image element with adequate signal strength and improved adhesion to a wide range of substrates. The magnetic waveform signal strengths for Magnetic Ink Character Recognition (MICR) character printed using the preferred embodiments of the proposed invention are 100-120% for “on-us” characters which are the characters usually printed to the left of the routing field on the MICR line often used for commercial checks for the placement of consecutive serial numbers like on a check or like but could be other similar locations relative to a first location. MICR character signal strength was measured using an RDM MICR qualifier produced by RDM Corporation. The qualifier measured the magnetic signal intensity of the MICR characters printed on the receiver. The industry standard requires magnetic signal strength of MICR characters to be between 50% and 200%.

The image elements printed and fixed using the proposed invention shows increased resistance to abrasion when passed through an industry standard reader-sorter. Reading and sorting of checks is the primary application of magnetic toner print images. The industry standard equipment is the IBM 3890 high-speed reader-sorter. Toner print images are routinely subjected to repeated passes through the equipment as the check is routed from its point of use to its bank of origin. A standard test is used to determine the reader/sorter performance of the magnetic toner images printed by the proposed invention. The test involves the following steps:
1. Print 1000 toner images with a properly formatted character line and well-defined font.
2. Read/Sort the toner images by passing through the IBM 3890 Reader/Sorter.
3. Remove images that the reader/sorter rejects for any reason
4. Repeat steps 2 and 3, which together form a “pass”, for a total of 20 passes.
5. Calculate the reject rate as the number of image failures divided by the total number of reading/sorting events.

### For example, if 1000 check images were passed through the reader/sorter and 1 image was rejected on each pass, the reject rate would be 20 rejects divided by 20000 reading/sorting events or a 0.1% reject rate.

Table 1 shows the marked improvements of magnetic toner image elements printed using the proposed inventive system over competitive systems.

TABLE 1

| | IBM 3890 |
|---|---|
| | Reader/Sorter |
| Print System | Reject Rate |
| Benchmark A | 1.25% |
| Benchmark B | 0.20% |
| Benchmark C | 0.40% |
| Proposed Invention | 0.04% |

In addition to improved reader/sorter reject rates, the signal loss due to abrasion of the toner image elements is also improved. Table 2 shows the percentage of magnetic signal lost by magnetic toner image elements passed through the reader/sorter 20 times. Signal loss is due to removal of the printed material by the read and write heads in the reader/sorter. The magnetic signal strength of toner image elements was measured before and after reader/sorter testing and the % decrease in the magnetic signal is reported.

TABLE 2

| | Magnetic Image |
|---|---|
| | Element |
| Print System | Signal Loss |
| Benchmark A | 4.00% |
| Benchmark B | 0.95% |
| Benchmark C | 7.50% |
| Proposed Invention | 0% |

The combination and order of application of image elements by the imaging units make for an array of security features that can be embedded in the document and/or provide magnetic toner characters with greatly improved adhesion to substrates. Examples of the various schemes are detailed below.

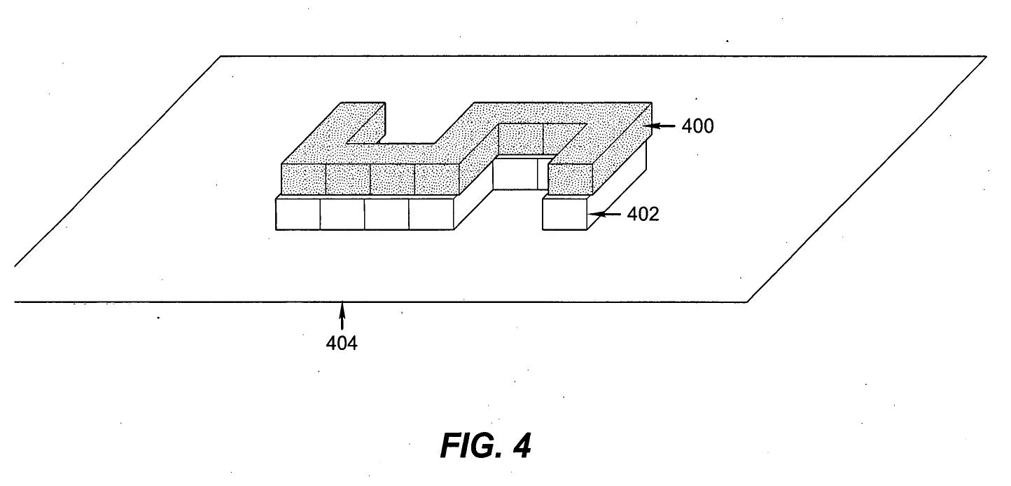

Referring now to FIG. 4, one or more first toner image elements 402 are printed on the receiver 404 and subsequently overprinted in whole or in part with second toner image elements 400. In this preferred embodiment, the first toner image elements 402 have a first characteristic, here a first color. Second toner image elements 402 have a second characteristic, a second color that can exceed the sides of the first toner image element and create a halo effect on at least one part of the first image element. Also. upon fixing the toner on toner combination can be further processed by heat and pressure so that the second toner image elements change the image quality of the first image element upon fixing. For example if printed alone, the inherently high viscosity and elasticity of the first toner would preferentially fix to a matte finish. When the first toner image element is overprinted by a lower viscosity, less elastic, second toner, the overprinted toner fixes to a highly glossed finish. Document security is realized when attempts to alter the content of the first toner image elements create a change or discontinuity in the apparent gloss of the altered first/second toner image element composite.

The slightly wider under-character in a contrasting color would provide a halo-effect around each character, making any tampering with the original image become readily apparent. The under color could be either held to tight standards or allowed to slowly vary. If the color is tightly held to a tiny gamut, say for each company, then checks from that company could be easily identified and any attempts to reprint such a check would require great skill on the part of the fraudster. If the under color is allowed to vary, then any text replacement would be identified by a break in the continuous nature of the color variation as well as making it difficult for a fraudster to color match the halo in the area of concern, say the payee or amount field.

Such an under color character would need to be only a few thousandth's of an inch larger than the top character, but would require very careful registration. The NexPress 2100 not only has the capability for a gamut of colors, but the registration capability to put everything in register. The lower character does not need to be intense in color, a pale image will do, assuming the chosen under color contrasts with the color of the substrate surface. Different color combinations could be used but would be limited to the order of colors in the printer. This characteristic of multiple colors in good registration allows for part of an in-filled character to be one color and the adjacent part of the same character a different color, either side-by-side or top and bottom. This technique would give the secure in-filled characters distinctive look and any tampering with the image would be easily detected.

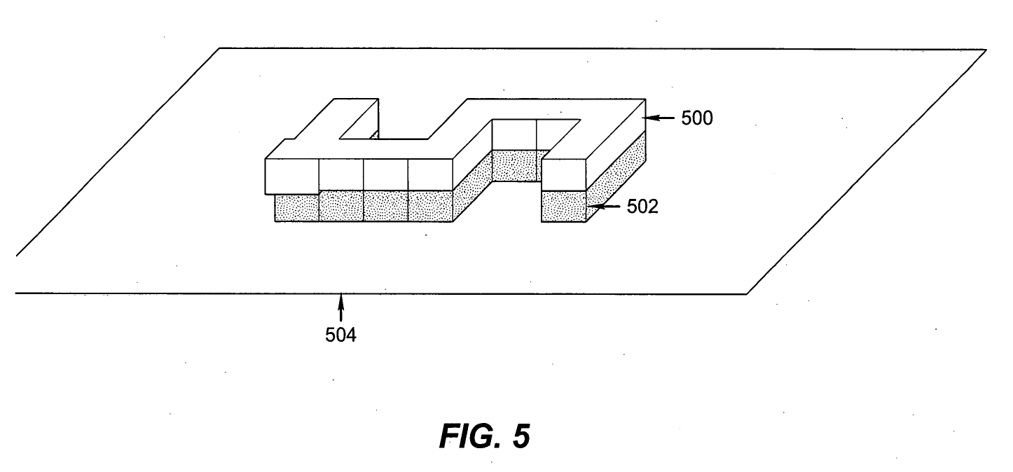

Referring now to FIG. 5, second toner image elements 502 are printed on the receiver 504 and subsequently overprinted by first toner image elements 500. The co-printed image is then has a so-called reverse halo wherein the top or first image element overruns or “hangs over” the lower or second image element. The second toner may or may not contain optical, UV, or IR pigments. The second toner image elements will also be applied to the receiver at an optical transmission density of 0.01 to 5.00. Fixing of the combined first and second toner image elements results in an image element with adequate signal strength and improved adhesion to a wide range of substrates.

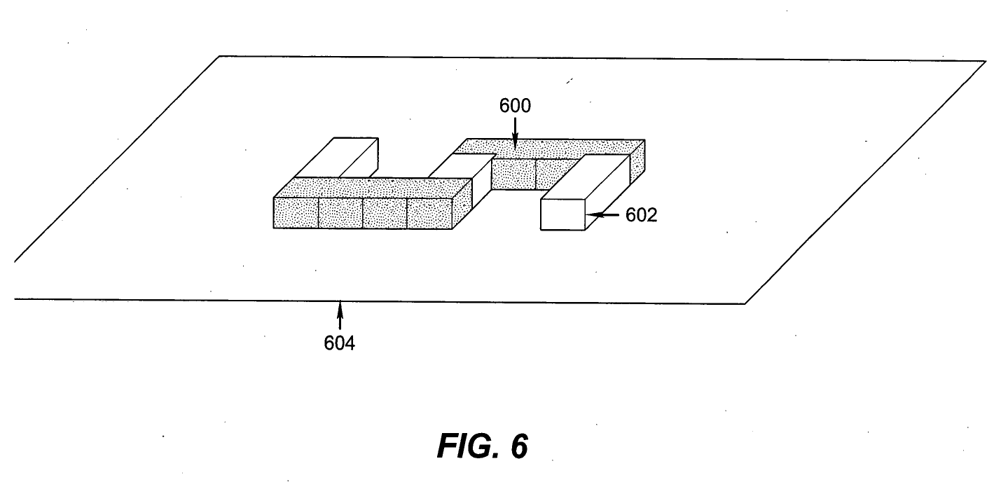

Referring now to FIG. 6, second toner image elements 600 are printed adjacent to first toner image elements 602 and the co-printed image is fixed by heat and pressure. First and second image elements are printed beside one another such that neither the first nor the second image elements extend over the other. The resulting co-printed and fixed image contains both first and second toner but would appear to be composed of second toner only. Furthermore, the first and second image elements may be arranged in such a way as to encode information that could be decoded at the point of use to determine authenticity.

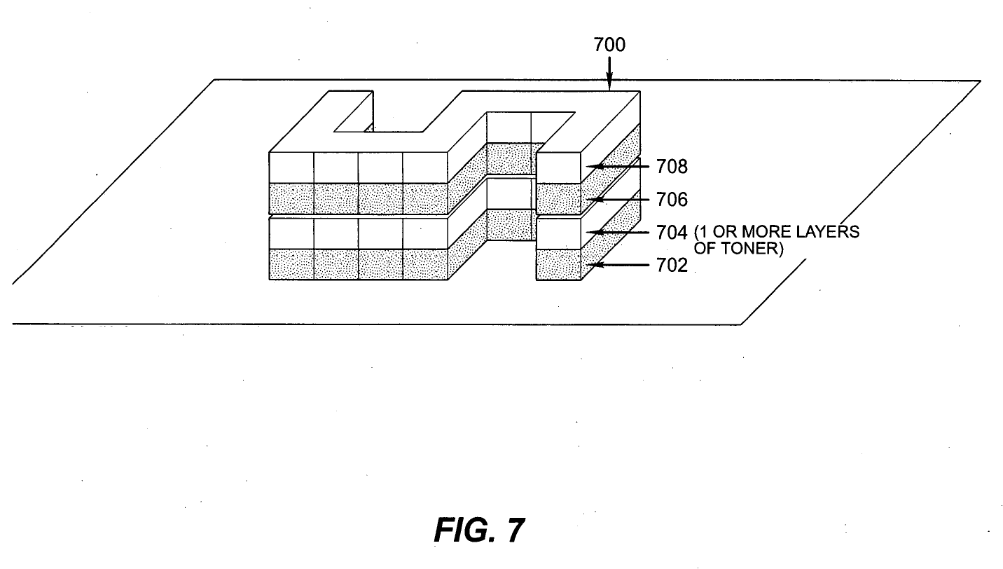

Referring now to FIG. 7, substrate 700 is a substrate to which adhesion is difficult for the high viscosity 80 kcP first toner. First printing second toner image elements of 10 kcP viscosity and overprinting these with one or more layers of high viscosity first or second toners, 704, 706, and 708 can improve adhesion of the first toner. This toner stack can furthermore be overprinted with yet another low viscosity toner to impart a high degree of gloss to the otherwise matte image that would result from the high viscosity toner. Using the scheme shown in FIG. 7, many degrees of gloss can be imparted to the image by mixing various amounts and coverages of the low viscosity toner. The result of this toner layering is a well-adhered first toner with a high degree of gloss in the image, yet adequate first signal strength to serve as a MICR image.

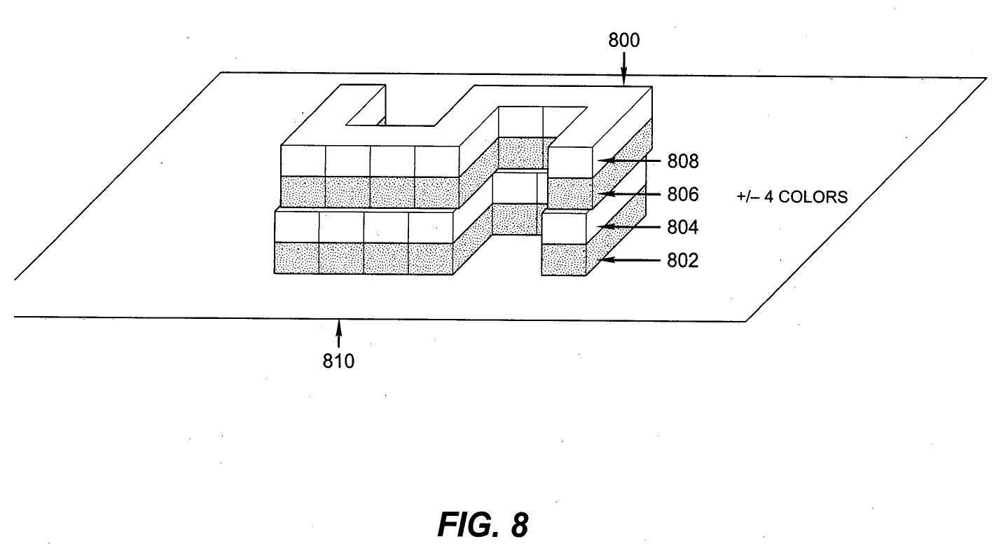

Referring now to FIG. 8, the first high viscosity toner can be first printed on the substrate 800 and further overprinted with one or more layers of high viscosity first or second toner. Over the final layer of high viscosity toner can furthermore be printed a layer or partial layer of second low viscosity toner to impart a desired degree of gloss to the image. Lower coverages of the low viscosity toner will result in low gloss to the image while higher coverage of the low viscosity toner will result in a higher image gloss. Furthermore, the image elements are fixed at a single temperature and pressure.

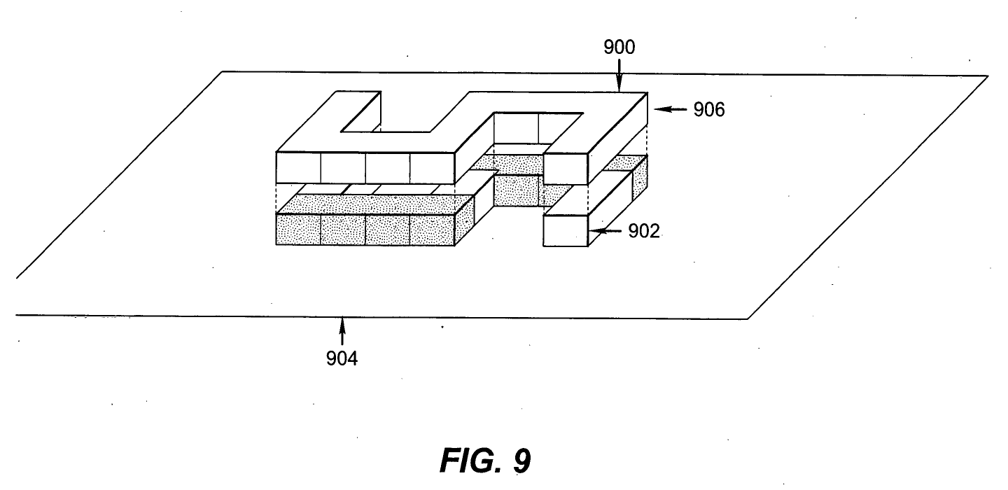

Referring now to FIG. 9, information content may be encoded into the image via first 902 and second 906 toner image elements applied adjacent to one another on substrate 904. The arrangement of these toner image elements may produce a pattern that is read via magnetic, optical, IR, UV or other transduction methods known in the art. However, if high viscosity first toner image elements are printed next to low viscosity toner image element, a differential gloss will appear in the image. This is avoided in the embodiment illustrated in FIG. 9. by overprinting the first and second image elements with a low or high viscosity toner such that the total image is fixed to a uniform gloss level.

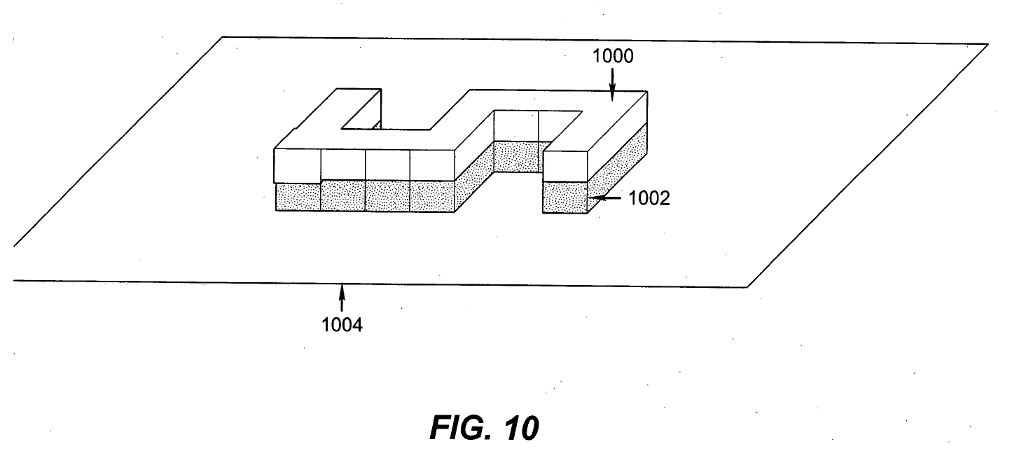

FIG. 10 shows another embodiment, a type of occult printing that prints one toner with a density calculated to cover up, or occlude with a surface toner 1000 density equal or greater than that of another toner 1002, referred to as the undertoner or undercolor, so that instead of seeing the undercolor 1002 through the surface toner layer 1000, the undercolor 1002 can be covered up with surface toner 1000 so that the undercolor can only be seen in transmitted light, thereby rendering it safe from photocopying, e.g. company logo or official seal and/or the undercolor can be seen by lightly scraping the top of the toner deposit, allowing the undercolor to be seen and verifying that the document is genuine and has not been so verified previously. In a preferred embodiment the surface toner 1000 is solid or a halftone of greater than 90%. The undertoner can contain other material, such as MICR as described in co-pending application Ser. No. 11/102,349 entitled “Hidden MICR Printing for Security” and filed Apr. 8, 2005. In another preferred embodiment the undercolor is a lighter color than the surface toner 1000.

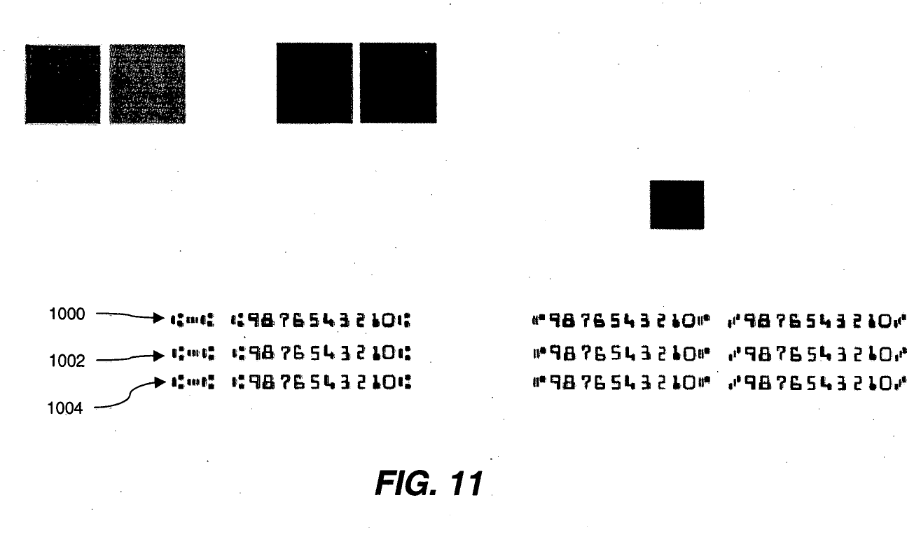

FIG. 11 shows reproductions of actual first and second characters printed using the methods described above. 1100 shows a line of second toner image elements overprinted by first toner image elements. 1102 shows first and second toner image elements printed adjacent to one another. 1104 shows first toner image elements overprinted by second toner image elements.

1. A method of generating secure documents comprising:
a. selecting a first toner for a first image element and second toner for a second image element such that the first toner and the second toner are different;
b. printing the first toner on a receiver;
c. coprinting the second toner, prior to fixing, on the receiver proximate to and overlying at least a portion of the first toner; and
d. fixing the toners on a fixed print.

2. The method of claim 1, the first and/or second toner further comprising one or more colored toners including black.

3. The method of claim 1, the first and/or second toner further comprising one or more colored toners including magnetic toner.

4. The method of claim 1 the first and/or second toner further comprising a clear toner.

5. The method of claim 4, the clear toner, further comprising UV or other light sensitive additives.

6. The method of claim 1 further comprising printing on a pixel-by-pixel basis both the first toner and the second toner such that one is larger than the other on at least one side.

7. The method of claim 6 further comprising overlying a first upper toner over a pixel-by-pixel second lower toner such that the second toner creates a halo by extending beyond a portion of the first toner.

8. The method of claim 6 further comprising varying one toner over a pixel-by-pixel other toner such that the one toner variably creates a halo by extending beyond a portion of the other toner based on set criteria.

9. The method of claim 8 further comprising varying the halo by one or more of customer, time, content and context.

10. The method of claim 6 further comprising overlying one toner over a pixel-by-pixel other toner such that the one toner creates a halo by extending beyond a portion of the other toner.

11. The method of claim 10 further comprising determining the font and point size of the first image element and adding pixels on one or more portions to create at least a partial halo.

12. The method of claim 1 further comprising comparing the first image element to the second image element to make sure not observably distinct and adjust to make indistinguishable.

13. The method of claim 1 wherein the second image element is printed after the first toner is fixed.

14. The method of claim 1 wherein the first toner is printed over the second toner to occlude the second image element.

15. The method of claim 14 wherein the first toner comprises a density equal or greater than that of the second toner.

16. The method of claim 14 wherein the first toner comprises a solid or halftone greater than 90%.

17. A method of generating secure documents comprising:
a. printing a first image element on a receiver with a first toner on an area prior to fusing;
b. co-printing a second image element proximate the first image element with a second toner proximate the same area prior to fusing; and
c. selecting the first color for the first toner image element to produce a first final image element color and the second color for the second toner image element to produce a second toner image element color such that the first toner image element color and the second toner image element color are indistinguishable to an observer.

18. The method of claim 17, the first and second toners further comprising one or more colored toners.

19. The method of claim 17 further comprising a clear toner.

20. The method of claim 19, further comprising UV or other light sensitive additives in the clear coating.

21. The method of claim 17 further comprising overlying one image element over a pixel-by-pixel other image element such that the one image element creates a halo by extending beyond a portion of the other image element.

22. A secure document comprising:
a. a preprinted receiver;
b. a first image element comprising a first toner printed on the preprinted receiver; and
c. a second image element comprising a second toner such that the first toner and the second toner are different, coprinted on the preprinted receiver, prior to fixing, proximate to and overlying at least a portion of the first toner.

23. The document of claim 22, the first and/or second toner further comprising one or more colored toners including black.

24. The document of claim 22, the first and/or second toner further comprising one or more colored toners including magnetic toner.

25. The document of claim 22, the first and/or second toner further comprising a clear toner.

26. The document of claim 25, the clear toner, further comprising UV or other light sensitive additives.

27. The document of claim 22, further comprising printing on a pixel-by-pixel basis both the first toner and the second toner such that one is larger than the other on at least one side.

28. The document of claim 27 further comprising overlying a first upper toner over a pixel-by-pixel second lower toner such that the second toner creates a halo by extending beyond a portion of the first toner.

29. The document of claim 27 further comprising varying one toner over a pixel-by-pixel other toner such that the one toner variably creates a halo by extending beyond a portion of the other toner based on set criteria.

30. The document of claim 29 further comprising varying the halo by one or more of customer, time, content and context.

31. The document of claim 27 further comprising overlying one toner over a pixel-by-pixel other toner such that the one toner creates a halo by extending beyond a portion of the other toner.

32. The document of claim 31 further comprising determining the font and point size of the first image element and adding pixels on one or more portions to create at least a partial halo.

33. The document of claim 22 further comprising comparing the first image element to the second image element to make sure not observably distinct and adjust to make indistinguishable.

34. The document of claim 22 wherein the second image element is printed after the first toner is fixed.

35. The document of claim 22 wherein the first toner is printed over the second toner to occlude the second image element.

36. The document of claim 35 wherein the first toner comprises a density equal or greater than that of the second toner.

37. The document of claim 22 wherein the first toner comprises a solid or halftone greater than 90%.
